(19) United States
(12) Patent Application Publication
(10) Pub. No.: US 2008/0116732 A1
(43) Pub. Date: May 22, 2008

(54) Device for use with a wheelchair

(76) Inventor: Herschel Hiatt, El Paso, TX (US)

Correspondence Address: The Halvorson Law Firm, Ste 130, 1757 E. Baseline Rd., Gilbert, AZ, 85233, US

(21) Appl. No.: 11/601,983

(22) Filed: Nov. 20, 2006

(51) Int. Cl. A61G 5/12

(52) U.S. Cl. 297/423.17

(57) ABSTRACT

A device, which is removably attachable to a wheelchair. The device comprises a footrest having a top section and a bottom section, which is spaced apart from the top section. The distance between the top and bottom sections may be spanned by a facing, braces or other distance spanning support structures. Attached to the footrest is a cushion support. Preferably the cushion support is attached to the top section of the footrest, but alternately may be attached to the bottom section or support structures. In one embodiment the cushion support is attached by at least one, preferably two, L-shaped brackets. Alternately, the cushion support may be unitarily formed onto the top section, such as when using injection molding or the like. Finally the cushion support may have width adjustment in order to fully vary the width of the cushion support.

### FIELD OF THE INVENTION

The present invention relates to the field of devices that are used with wheelchairs. More specifically, the present invention relates to devices that aid in supporting leg cushions used with wheelchairs.

### BACKGROUND

A wheelchair is a wheeled mobility device in which the user sits. The device is propelled either manually (by pushing the wheels with the hands) or via various automated systems. Wheelchairs are used by people for whom walking is difficult or impossible due to illness, injury, or disability.

Manual wheelchairs are those that require human power to move them. There are three types of manual wheelchair: self-propelled, attendant-propelled, and wheelbase. Almost all manual wheelchairs can be folded for storage or placement into a vehicle. A basic standard manual wheelchair is a tubular framework that supports a seat. It has four wheels, two small front wheels and two large rear wheels. Additionally, wheelchairs typically include a pair of movable footrests that support the legs and feet of the user. These footrests are attached to the corners of the wheelchair frame, leaving a large gap behind a persons legs.

Since most wheelchairs are standard models, there are many people who do not exactly fit the chair portion and require some form of support behind their legs, typically cushions or pillows. The large gap between the footrest attachment arms prevents the easy and convenient placement of such cushions without their falling off of the chair.

Thus, there are present and continuing needs for new and improved devices that help support leg cushions used with wheelchairs.

### SUMMARY OF THE INVENTION

It is an object of the present invention to provide a device for the support of cushions used with wheelchairs.

It is another object of the present invention to provide a device that supports cushions placed behind a users legs when sitting in a wheelchair.

It is a further object of the present invention to provide an adjustable device that allow width, height and depth adjustment of a cushion support for use behind a wheelchair user's legs.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

FIG. 1 is illustrates a person, in a wheelchair, using the present invention.

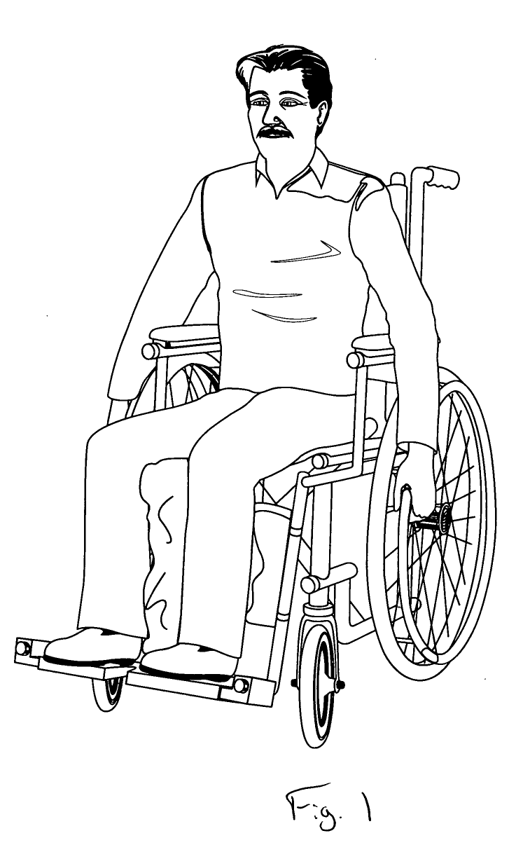

FIG. 2 is a front view of the present invention, in dashed outline is a pillow being supported by the present invention.

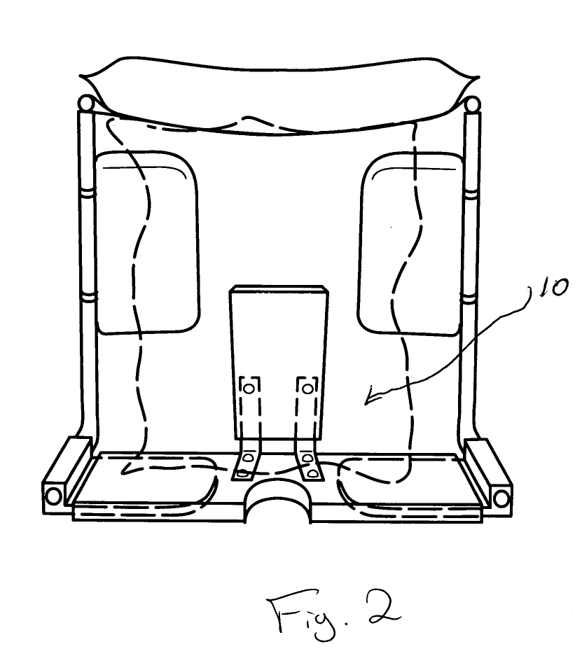

FIG. 3 is a front view illustration of how the present invention is placed onto a wheelchair.

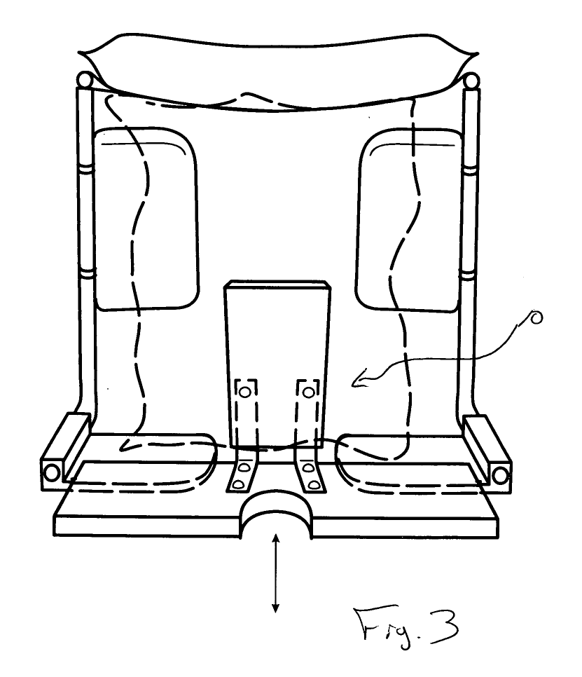

FIG. 4 is a perspective view of one embodiment of the present invention.

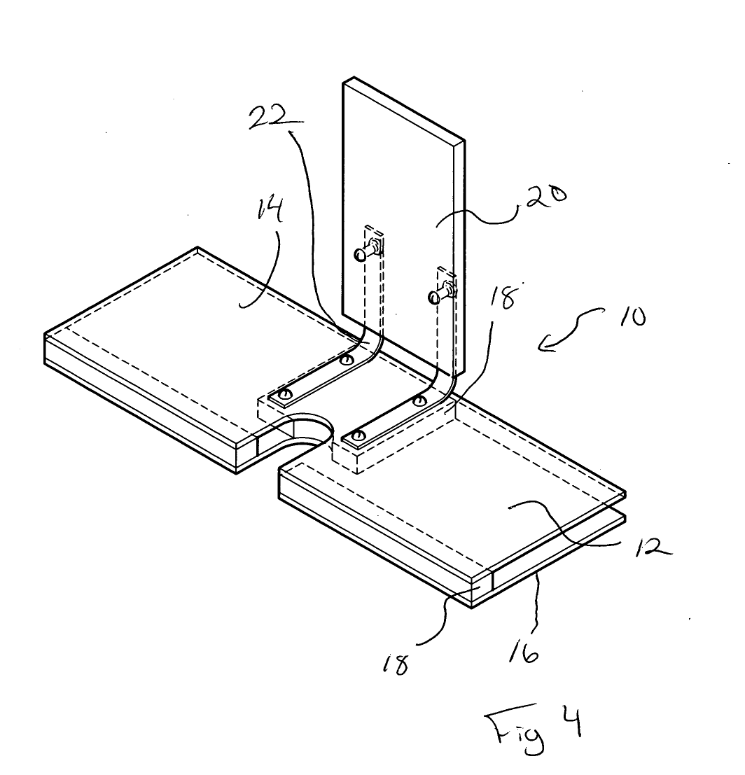

FIG. 5 is a perspective view illustration of how the present invention is placed onto a wheelchair.

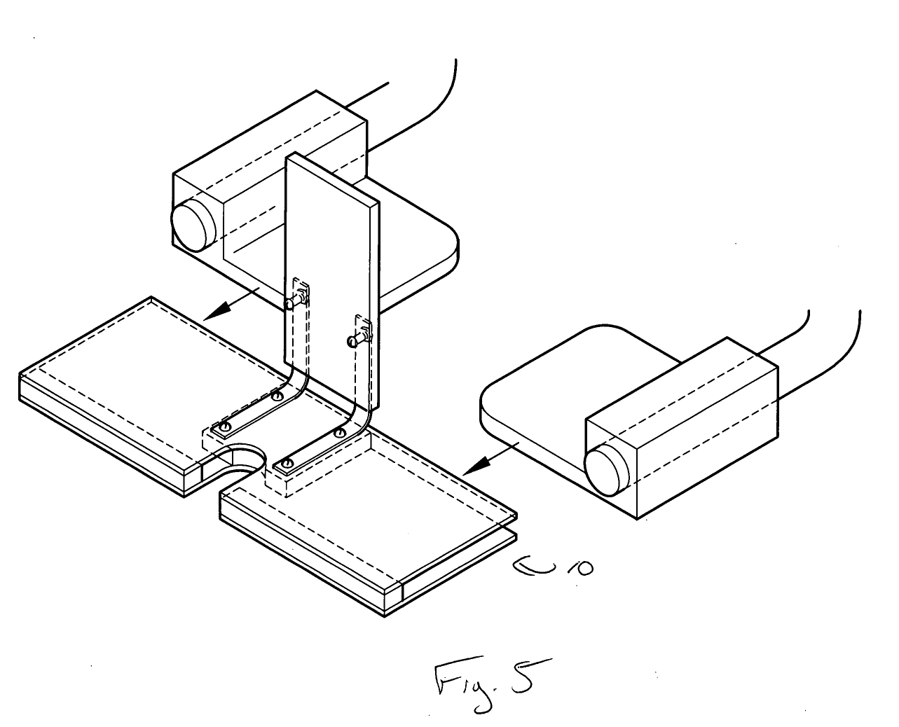

FIG. 6 illustrates one embodiment of how the present invention is expandable for larger sized wheelchairs.

### DESCRIPTION OF PREFERRED EMBODIMENTS

With reference to the figures, the present invention is useful for supporting cushions used behind a wheelchair users legs.

The present invention is a device 10, which is removably attachable to a wheelchair. The device 10 comprises a footrest 12 having a top section 14 and a bottom section 16, which is spaced apart from the top section 14. The distance between the top and bottom sections 14 and 16 may be spanned by a facing, braces or other distance spanning support structures 18.

Attached to the footrest 12 is a cushion support 20. Preferably the cushion support 20 is attached to the top section 14 of the footrest 12, but alternately may be attached to the bottom section 16 or support structures 18. In one embodiment the cushion support 20 is attached by at least one, preferably two, L-shaped brackets 22. Alternately, the cushion support 20 may be unitarily formed onto the top section 14, such as when using injection molding or the like. Finally the cushion support 20 may have width adjustment in order to fully vary the width of the cushion support 20.

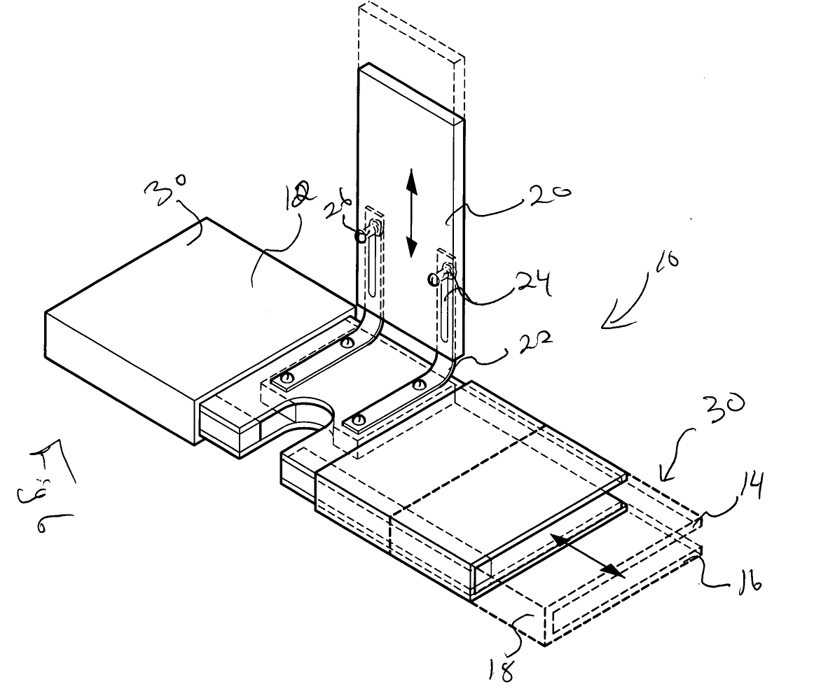

Preferably, the cushion support 20 is height adjustable such that more, or less, of the cushion is ultimately supported, as the user desires. One version of the adjustability, illustrated in FIG. 6, utilizes an attachment mechanism 24 such as slots formed into L-shaped brackets 22. Screws or bolts 26 in the cushion support 20 fit within the slots 24 and may be tightened in order to secure the height position of the cushion support 20. Alternately, a number of apertures may be formed into the L-shaped brackets 22 to provide the adjustability. Further, these slots and apertures may be formed in the cushion support 20 itself and the screws or bolts 26 may be fixedly placed in the L-shaped brackets 22.

The width of the footrest 12 is fully adjustable by a width adjustment mechanism. In one embodiment of the footrest, illustrated in FIG. 6, the width adjustment mechanism comprises an outer cover 30 on each side of the footrest 12 that slides outward in order to provide width adjustability. Alternately, the width adjustment mechanism compromises the two sides of the footrest 12 being separately formed and attached to a central bracket which has either slots or apertures for width adjustability.

The depth, or forward position of the cushion support 20 may be adjustable by providing the same slots or apertures on the bottom portion of the L-shaped brackets 22 as those that provide height adjustability. Further, the angle between the cushion support 20 and the footrest 12 may vary using an adjustable pivot located at the angle in the attachment mechanism 24 (not shown), which allows the cushion support 20 to be folded flat onto the top section 14 of the footrest 12 for easy transport and storage.

Finally, the device may include cushioning on either, or both, the footrest and/or the cushion support. Straps may be included on the cushion support or footrest to aid in securing the device to the wheelchair or cushions to the cushion support structure.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A device for providing cushion support on a wheelchair comprising a footrest comprising a top section attached to a bottom section by a facing, whereby a space is formed between the top section and bottom section that is capable of receiving the footrest portions of a wheelchair and a cushion support attached to the footrest.

2. The device according to claim 1 wherein the attachment between the footrest and the cushion support comprises a height adjustable attachment mechanism.

3. The device according to claim 1 wherein the attachment between the footrest and the cushion support comprises a depth adjustable attachment mechanism.

4. The device according to claim 1 wherein the attachment between the footrest and the cushion support comprises a height and depth adjustable attachment mechanism.

5. The device according to claim 1 wherein the footrest further comprises a width adjustment mechanism.

6. The device according to claim 2 wherein the footrest further comprises a width adjustment mechanism.

7. The device according to claim 3 wherein the footrest further comprises a width adjustment mechanism.

8. The device according to claim 4 wherein the footrest further comprises a width adjustment mechanism.

9. A method for supporting cushions on a wheelchair comprising the steps of providing a device for providing cushion support on a wheelchair comprising a footrest comprising a top section attached to a bottom section by a facing, whereby a space is formed between the top section and bottom section that is capable of receiving the footrest portions of a wheelchair and a cushion support attached to the footrest, inserting the footrest of the device over the footrests of the wheelchair to attached the device to the wheelchair, and placing a cushion on the cushion support of the device.

10. The method according to claim 9 wherein the attachment between the footrest and the cushion support comprises a height adjustable attachment mechanism.

11. The method according to claim 9 wherein the attachment between the footrest and the cushion support comprises a depth adjustable attachment mechanism.

12. The method according to claim 9 wherein the attachment between the footrest and the cushion support comprises a height and depth adjustable attachment mechanism.

13. The method according to claim 9 wherein the footrest further comprises a width adjustment mechanism.

14. The method according to claim 10 wherein the footrest further comprises a width adjustment mechanism.

15. The method according to claim 11 wherein the footrest further comprises a width adjustment mechanism.

16. The method according to claim 12 wherein the footrest further comprises a width adjustment mechanism.
